(19) United States
(12) Patent Application Publication
(10) Pub. No.: US 2014/0198293 A1
(43) Pub. Date: Jul. 17, 2014

(54) ELECTRONIC EYEWEAR

(71) Applicant: IpVenture, Inc., Los Altos, CA (US)

(72) Inventors: Jason Sweis, San Jose, CA (US); Vivian Liane Rice, Campbell, CA (US); David Chao, Saratoga, CA (US); Zhiyang Guo, Hercules, CA (US)

(73) Assignee: IpVenture, Inc., Los Altos, CA (US)

(21) Appl. No.: 14/217,174

(22) Filed: Mar. 17, 2014

Related U.S. Application Data
(63) Continuation-in-part of application No. 13/615,447, filed on Sep. 13, 2012.
(60) Provisional application No. 61/792,481, filed on Mar. 15, 2013.
(60) Provisional application No. 61/535,341, filed on Sep. 15, 2011.
(60) Provisional application No. 61/556,083, filed on Nov. 4, 2011.

(51) Int. Cl. G02C 11/00

(52) U.S. Cl. CPC G02C 11/10
USPC 351/158

(57) ABSTRACT

Embodiments for systems, methods and apparatuses of eyewear are disclosed. One apparatus includes a frame that includes a pair of temple arms forming eyewear that is adaptable to hold one or more lenses, and at least one switch, wherein the at least one switch is open or closed depending upon an angle of at least one of the temple arms relative to a frontal plane of the one or more lenses.

### CROSS-REFERENCE TO RELATED APPLICATIONS

This patent application claims the benefit of U.S. Provisional Patent Application No. 61/792,481, entitled “Electronic Eyewear,” filed Mar. 15, 2013, which is hereby incorporated herein by reference.

This patent application is a continuation-in-part of U.S. patent application Ser. No. 13/615,447, entitled, “Shutter Glasses”, filed Sep. 13, 2012, which is hereby incorporated herein by reference, which in turn claims priority to U.S. Provisional Patent Application No. 61/535,341, filed Sep. 15, 2011, which is hereby incorporated herein by reference; and U.S. Provisional Patent Application No. 61/556,083, filed Nov. 4, 2011, which is hereby incorporated herein by reference.

### FIELD OF THE DESCRIBED EMBODIMENTS

The described embodiments relate generally to electronic eyewear. More particularly, the described embodiments relate to apparatuses, methods and systems for electronic eyewear that monitors the use of the electronic eyewear.

### BACKGROUND OF THE INVENTION

In newborn children, the nerves and brain function that control eye movement and image processing begin to converge during the first 9 months after birth. Sometimes this natural process can go wrong and their eyes can start to cross inward (esotropia) or separate outwards (exotropia). This can prevent the brain from receiving simultaneous overlapping images from each eye to provide a true 3D depth realization. Surgery is sometimes needed to bring the eyes back into reasonable alignment but the brain still may suppress one eye or the other. In other situations, though the eyes are aligned, one eye can become dominant and the other “lazy” (amblyopia). Again the brain needs to learn how to process the images from both eyes simultaneously and equally. The nerves that control the eye muscles and receive the input of each eye need to be trained such as for binocular or stereo vision.

In small children with vision problems, the best results happen if therapy is started before the age of six when the wiring becomes mostly permanent. The older the child gets, the harder it is to correct the defects. So their defective eyesight should be corrected as early as possible. However, there are challenges in working with very young children. For example, they have more difficulty comprehending the need for the therapy; and they may not be able to execute instructions for vision therapy, particularly when the tasks are boring to them. The challenge is further exacerbated when the training session requires performing certain tasks repetitively for a long duration of time.

Instead of performing vision therapy, some parents opt for corrective eye surgery. For example, surgery could bring crossed eye back into near alignment. However, even after the surgery, their brain still prefers to use one eye over another. They need to be trained or to be retrained to see with both eyes.

Such eye defects are not limited to small children. Adults may need vision therapy also. For example, according to one study, two or more percent of the population in the United States do not have stereo vision.

It is desirable to have methods, systems and apparatuses for providing vision therapy to address the eye ailments described above.

### SUMMARY OF THE INVENTION

An embodiment includes an apparatus. The apparatus includes a frame that includes a pair of temple arms forming eyewear that is adaptable to hold one or more lenses, and at least one switch, wherein the at least one switch is open or closed depending upon an angle of at least one of the temple arms relative to a frontal plane of the one or more lenses.

An embodiment includes another apparatus. The apparatus includes a frame forming eyewear that is adaptable to hold one or more lenses, a display, and a controller. The controller is operative to receive one or more commands, and display a use parameter of the eyewear on the display based on the one or more received commands.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a block diagram of electronic eyewear according to an embodiment.

FIG. 2 shows another block diagram of electronic eyewear according to another embodiment.

FIG. 3 shows another block diagram of electronic eyewear according to another embodiment.

FIG. 4 shows four different states of the electronic eyewear as determined by states of the switches of the electronic eyewear according to an embodiment.

FIG. 5 shows an electronic switch of the electronic eyewear according to an embodiment.

FIG. 6 shows another electronic switch of the electronic eyewear according to another embodiment.

FIG. 7 shows another electronic switch of the electronic eyewear according to another embodiment.

FIG. 8 shows another electronic switch of the electronic eyewear according to another embodiment.

FIG. 9 shows an embodiment of a display which displays operational use information of the electronic eyewear according to an embodiment.

FIG. 10 shows another block diagram of electronic eyewear according to another embodiment.

FIG. 11 shows a block diagram of electronic shutter glasses according to another embodiment.

FIG. 12 shows a block diagram of electronic shutter glasses according to another embodiment.

FIG. 13 shows shutter glasses in different states of operation according to an embodiment.

FIG. 14 shows time-lines of operation of the shutter glasses for the different states shown in FIG. 3, according to an embodiment.

FIG. 15 shows time-lines of operation of the shutter glasses for the different states shown in FIG. 3, according to another embodiment.

FIG. 16 shows shutter glasses that include an adjustable level of blocking, according to an embodiment.

FIG. 17 shows shutter glasses interfaced with an external controller, according to an embodiment.

FIG. 18 is a flow chart that includes steps of a method of operating shutter glasses, according to an embodiment.

### DETAILED DESCRIPTION OF THE INVENTION

At least one of the described embodiments includes one or more switches located on eyewear for providing commands to a controller of the eyewear, or for monitoring use of the eyewear. For an embodiment, the monitoring can be used by either a patient or a doctor to determine how long (either as a total duration and/or as finite duration of a period of time, such as, a day or a week, or a month) the user has worn the eyewear for therapeutic reason. For an embodiment, the monitoring provides or allows for providing an indicator of how well the user has complied (referred to as compliance) with a therapy recommended by the doctor. For an embodiment, the monitored use and/or compliance is displayable to the user on a display located on the electronic eyewear. For an embodiment, the monitored use and/or compliance is stored for future access (through, for example, an externally connected controller or computer) by the doctor. Base on the monitored use and/or compliance information, the doctor can confirm that the therapy is being properly applied (for example, patient complying to the recommended hours of wear) by the user, or the doctor may determine that the therapy needs to be updated.

For an embodiment, the monitored use and/or compliance is utilized by a user (patient) that has been proscribed the use of one or more of the described embodiments of shutter glasses. For an embodiment, the doctor uses the monitored use and/or compliance information to determine whether the shutter glasses are shuttering (blanking, or first or second blocking times) at the proper frequency and/or time period, or whether the frequency and/or time period of the shuttering should be adjusted. A user can develop a mental fatigue to particular blocking times or frequencies, and new particular blocking times or frequencies can be required to further therapy of the user (patient).

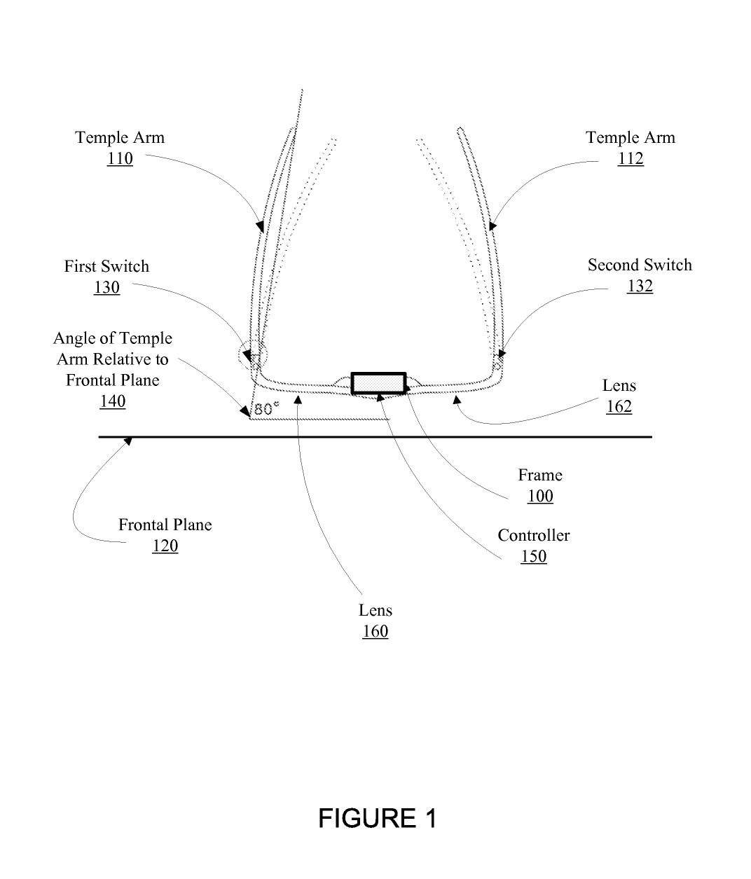

FIG. 1 shows a block diagram of electronic eyewear according to an embodiment. For this embodiment, the electronic eyewear includes a frame 100 that includes a pair of temple arms 110, 112 forming eyewear that is adaptable to hold one or more lenses (for example, lenses 160, 162). The electronic glasses further include at least one switch (for example, a first switch 130 and/or a second switch 132). For an embodiment, the at least one switch is open or closed depending upon an angle of at least one of the temple arms 110, 112 relative to a frontal plane 120 of the one or more lenses.

It is to be understood that while the embodiment of FIG. 1 is described as electronic eyewear, this embodiment includes glasses, goggles and other forms of eyewear, including what are sometimes referred to as “frame-less” glasses. Other embodiments of an eyewear include an eyewear without glasses, an auxiliary frame, and/or different types of glasses, such as sunglasses, fit-over glasses, prescription glasses, safety glasses, swim masks, and/or other types of goggles, such as ski goggles and diving goggles. While two lenses 160, 162 are depicted in FIG. 1, the electronic eyewear can include a single eye-piece forming glasses, which could be goggles. Further, embodiments of the frame 100 include a frame of glasses, a frame of goggles and a connecting piece between lenses of frameless glasses. Further, embodiments of the switches 130, 132 can be located between the frame 100 and the temple arms 110, 112, or between the at least one of the lens and the temple arms 110, 112. In yet another embodiment, temple arms of an electronic eyewear could be significantly shortened, and could be attached to a cord, or a band, such as a lanyard, which could be used to secure the eyewear to its wearer or user.

For an embodiment, the frontal plane includes an effective plane of the one or more lenses 160, 162. As shown, for an embodiment, at least one of the temple arms 110, 112 is rotatable about a point as determined by where the temple arm is connected (attached) to the eyewear. As a temple arm (such as, temple arm 110) is rotatably adjusted, an angle of the temple arm relative to the frontal plane (shown as angle 140) is varied. As shown in FIG. 1, for the position of the temple arm 110 relative to the frontal plane, and angle of temple arm relative to the frontal plane is approximately 80 degrees. For this embodiment, the angle can be adjusted between approximately 0 degrees to approximately 90 degrees.

In one embodiment, an eyewear includes a lens holder and two temples (which can also be known as temple arms), each temple connected to the lens holder via a hinge. Each temple could be folded in or extended out, based on its corresponding hinge. When a temple is fully folded in, the angle between the temple and the lens holder is substantially 0 degrees; and when the temple is extended out, in its typically stable condition, the angle between the temple and the lens holder is substantially 90 degrees. Note that for some eyewear, when a temple is urged to be fully extended out, the angle between the temple and the lens holder can be more than 90 degrees. In one embodiment, the angle between a temple and the lens holder is substantially the same as the angle 140 between a temple and the frontal plane as shown in FIG. 1.

In yet another embodiment, the frontal plane is substantially parallel to a back plane formed by the two hinges as previously described. For example, the back plane of a pair of glasses can be formed by placing the glasses with its lenses on its frontal plane, removing its temples and having a plane sitting on top of the two hinges. That plane can be the back plane.

For an embodiment, the at least one switch is located within at least one hinge formed between the frame and at least one of the pair of adjustable temple arms. As previously described, for an embodiment, the at least one hinge is formed between the at least one lens and at least one of the pair of adjustable temple arms.

For an embodiment, the at least one switch includes a spring mechanism that urges the at least one switch to be at least one of open or closed. For an embodiment, the at least one switch is located within at least one hinge formed between the one or more lenses and the pair of adjustable temple arms.

For an embodiment, the at least one switch is open or closed depending on whether the angle is less than or greater than X degrees. For an embodiment, X is approximately 80 degrees. For an embodiment, the at least one switch is closed if the angle is greater than X degrees, and open if the angle is less than X degrees. For an embodiment, the switches are electronic switches, and closing a switch enables an electronic current to be conducted through the switch, and opening the switch prevents an electronic current from being conducted through the switch.

For an embodiment, the at least one switch includes a first switch 130 located within a first hinge formed between the frame 100 and a first adjustable temple arm 110 of the pair of adjustable temple arms, and a second switch 132 located within a second hinge formed between the frame 100 and a second adjustable temple arm 112 of the pair of adjustable temple arms. For an embodiment, the first switch 130 is open or closed depending on whether a first angle (for example, angle 140) of the first hinge is less than or greater than X degrees, and the second switch 132 is open or closed depending on whether a second angle of the second hinge is less than or greater than Y degrees. For an embodiment, X is approximately equal to Y.

For an embodiment, the electronic eyewear includes a controller 150. The controller 150 of FIG. 1 is shown as being located between the viewing portions of the lenses (for example, between the lens 160 and the lens 162) which can be referred to as the bridge of the eyewear. However, the controller can be located in other area within the electronic eyewear.

For an embodiment, the controller 150 is operative to monitor a state of the electronic eyewear depending on whether the at least one switch is open or close. As described, if the switches are electronic switched, the switches are able to conduct current if close, and are not able to conduct current if opened. Therefore, the states (open or closed) can be sensed by electronic circuitry, and therefore, sensed or determined by the controller. For an embodiment, the monitored state comprises monitoring whether a user is wearing the glasses.

For an embodiment, the controller 150 is operative to monitor a state of the electronic eyewear by monitoring whether the first switch 130 is open or close and whether the second switch 132 is open or closed. For an embodiment, the monitored state comprises monitoring whether a user is wearing the glasses.

For an embodiment, the controller is operative to perform a command, wherein the command is determined based on whether the first switch is open or closed and whether the second switch is open or closed. For an embodiment, the command includes at least one of a system on/off command, a display functioning cycle-time, battery life display, an LCD frequency adjust, a reset. For an embodiment, a first command is performed if both the first switch and the second switch are closed, a second command is performed if the first switch is closed and the second switch is open, a third command is performed if the first switch is open and the second switch is closed, and a fourth command is performed if both the first switch and the second switch are closed. Clearly, fewer than four commands can be performed based on the state of the switches of the electronic eyewear.

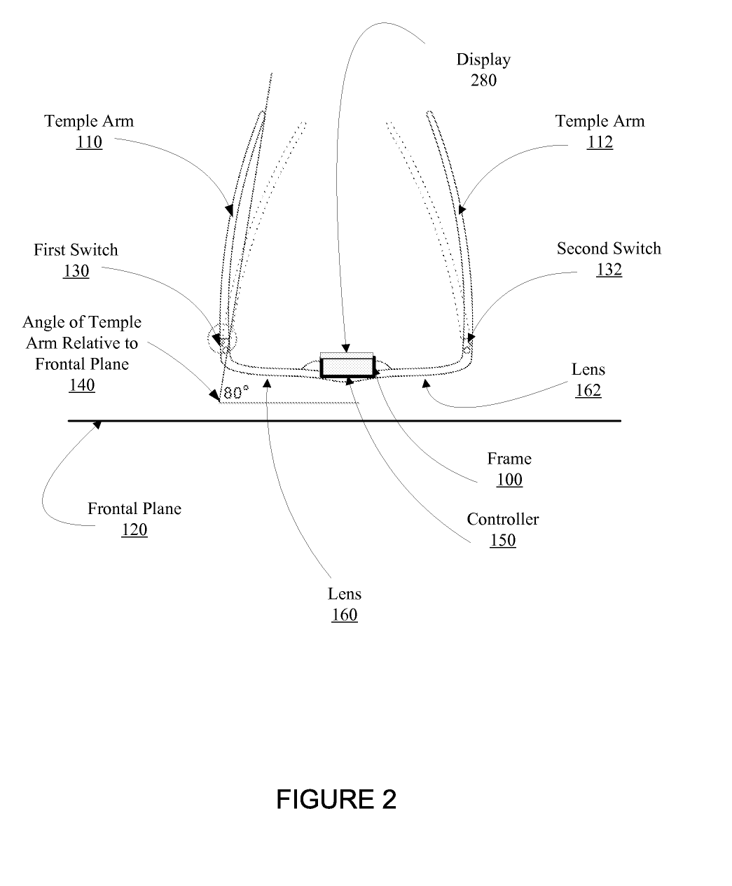

FIG. 2 shows another block diagram of electronic eyewear according to another embodiment. This embodiment further includes a 280 display located on or within the electronic eyewear, such as at the bridge or other area of the eyewear. For an embodiment, the display provides information. For an embodiment, the information provided is controlled by the controller 150. For an embodiment, the information provided is controlled by a controller external to the eyewear. For an embodiment, the command includes providing an indicator of how long the user has worn the glasses. For an embodiment, the command includes providing an indicator of how long the user has worn the glasses for a given day. For an embodiment, the display is located between the lenses on a side of the frame that is adjacent to or facing the user's eyes when wearing the eyewear.

For an embodiment, the electronic eyewear further includes a battery, and the command includes providing an indicator of a remaining lifetime of the battery.

The display can be used, for example, by the user to monitor how long and/or frequently the user has been wearing the glasses. The user can thereby monitor whether the user is properly following usage of the electronic eyewear as prescribed, for example, by a doctor or therapist. Further, operational use of the electronic eyewear can be monitored, and then the results of the monitoring accessed by the user by providing command inputs to the controller, causing the controller to provide the results on the display for observation by the user.

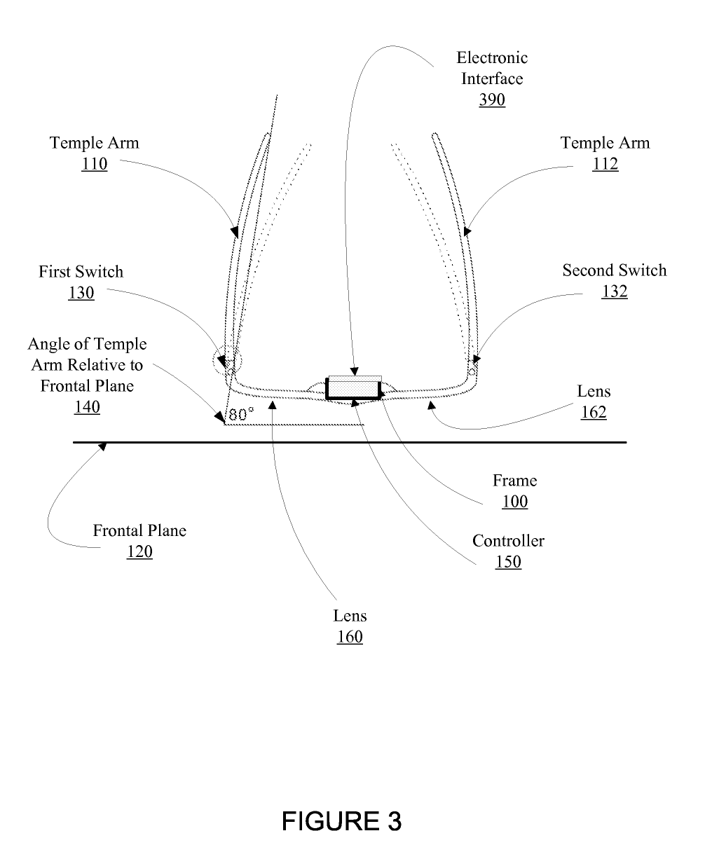

FIG. 3 shows another block diagram of electronic eyewear according to another embodiment. This embodiment further includes an electronic interface 390, such as at the bridge or at other area of the eyewear. For an embodiment, the electronic interface 390 allows the controller 150 to upload monitored behavior of the user of the electronic eyewear. For example, the states of the switches 130, 132 can be used to monitor whether the user has been wearing the electronic eyewear, and for how long. This is useful, for example, when a therapist or doctor is treating the eyes of the user. The therapist or doctor can access the monitored behavior of the user as stored in memory of the electronic eyewear. For an embodiment, the electronic interface is a wired interface that provides communication between the controller 150 and the external controller. For an embodiment, the electronic interface includes a wireless interface (wireless transceiver) and provides a wireless connection between the controller 150 and an external controller. For an embodiment, the controller 150 transmits and/or receives information (including commands) with a second (external) controller. The communication allows configuring the glasses (frequencies etc.) to be done remotely through a wireless network, such as a Bluetooth or Wifi network, via a portable device, such as IPad.

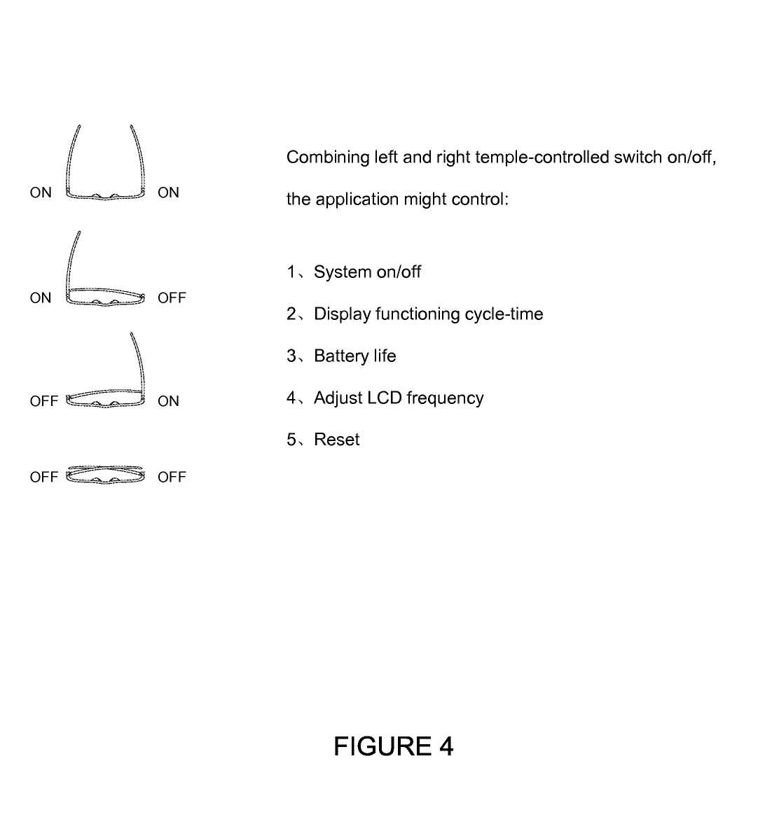

FIG. 4 shows four different states of the electronic eyewear as determined by states of the switches of the electronic eyewear according to an embodiment. That is, for this embodiment, a first state includes both switches closed, a second state include one switch close and one switch open, a third state includes the one switch open and one switch closed, and a fourth state include both switches open.

As shown in FIG. 4, the four states provided by opening or closing the switches of the electronic eyewear can be used as commands for the controller within the electronic eyewear. The commands can include, for example, a system on/of command, a display of the functioning cycle-time, a battery life, an adjustment to the shuttering frequency of the LCD lenses of the electronic eyewear, and/or a reset command.

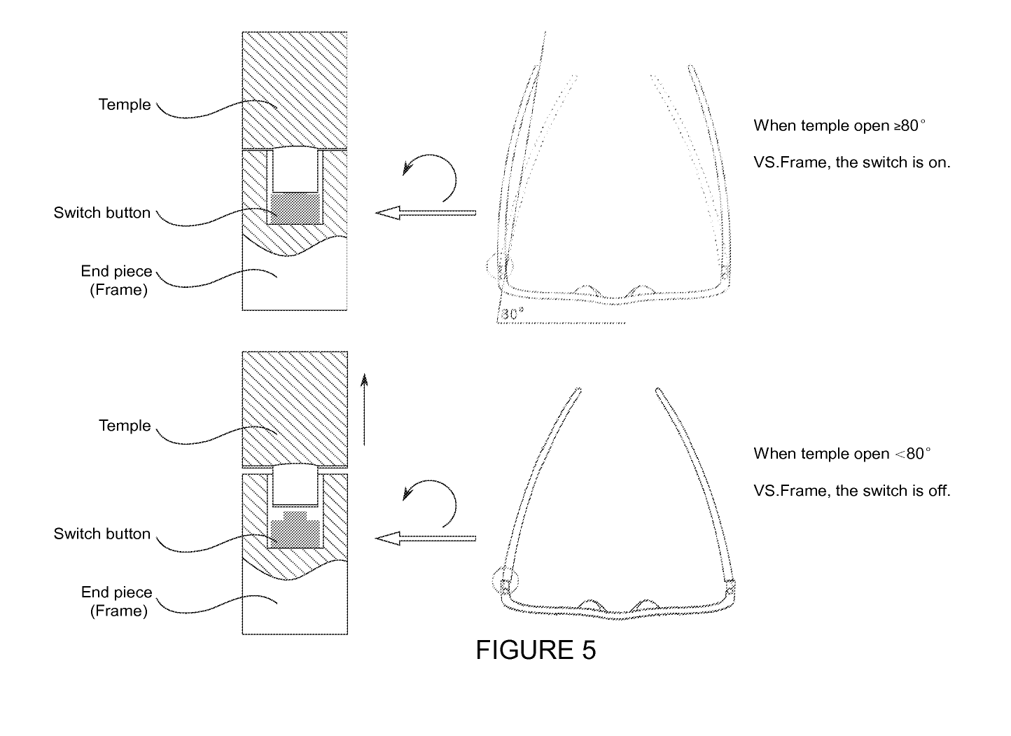

FIG. 5 shows an electronic switch of the electronic eyewear according to an embodiment. The electronic switch includes a switch button that is closed when the angle of at least one of the corresponding temple arms relative to a frontal plane of the lenses exceeds a predetermined angle.

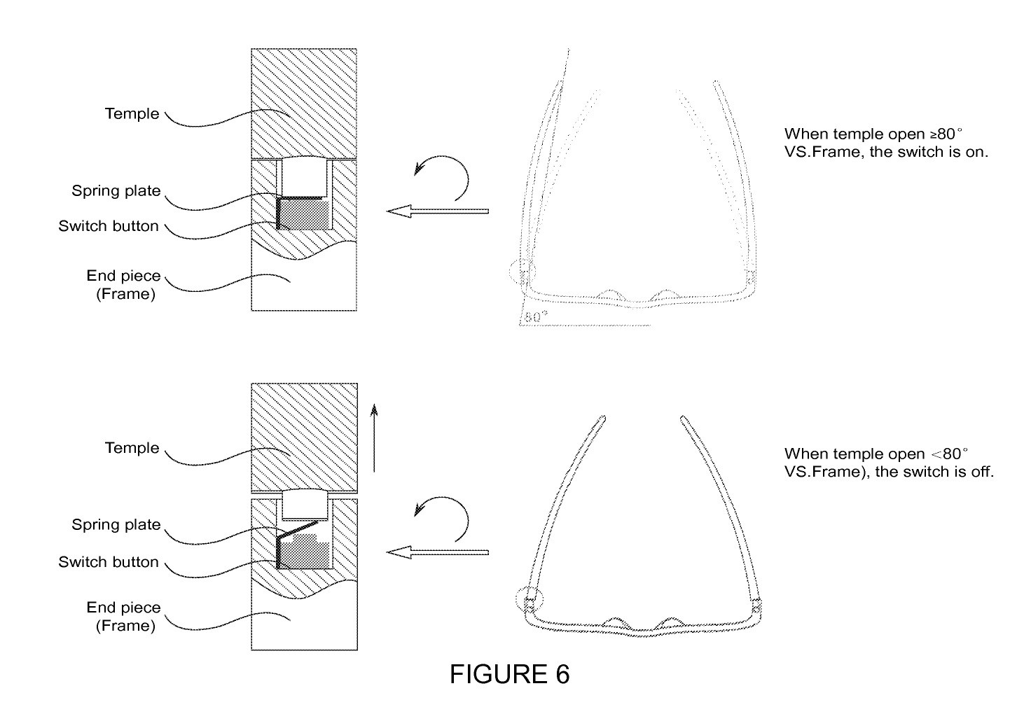

FIG. 6 shows another electronic switch of the electronic eyewear according to another embodiment. The electronic switch includes a spring mechanism and a switch button that is closed when the angle of at least one of the corresponding temple arms relative to a frontal plane of the lenses exceeds a predetermined angle.

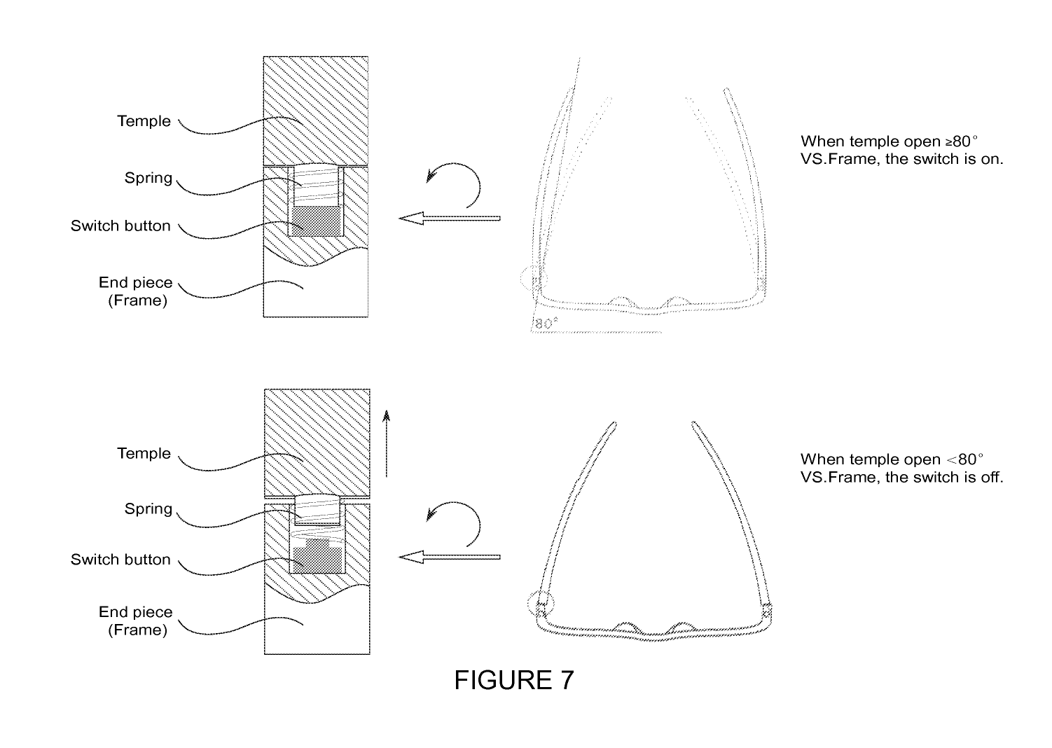

FIG. 7 shows another electronic switch of the electronic eyewear according to another embodiment. The electronic switch includes a spring mechanism and a switch button that is closed when the angle of at least one of the corresponding temple arms relative to a frontal plane of the lenses exceeds a predetermined angle.

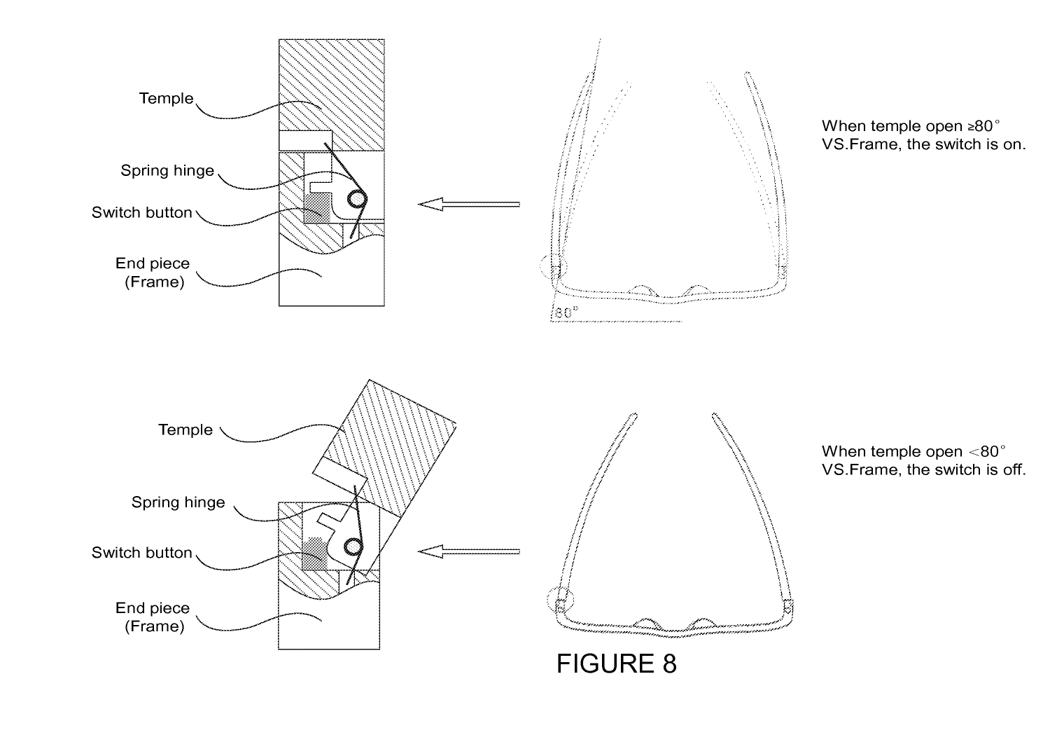

FIG. 8 shows another electronic switch of the electronic eyewear according to another embodiment. The electronic switch includes a spring mechanism and a switch button that is closed when the angle of at least one of the corresponding temple arms relative to a frontal plane of the lenses exceeds a predetermined angle.

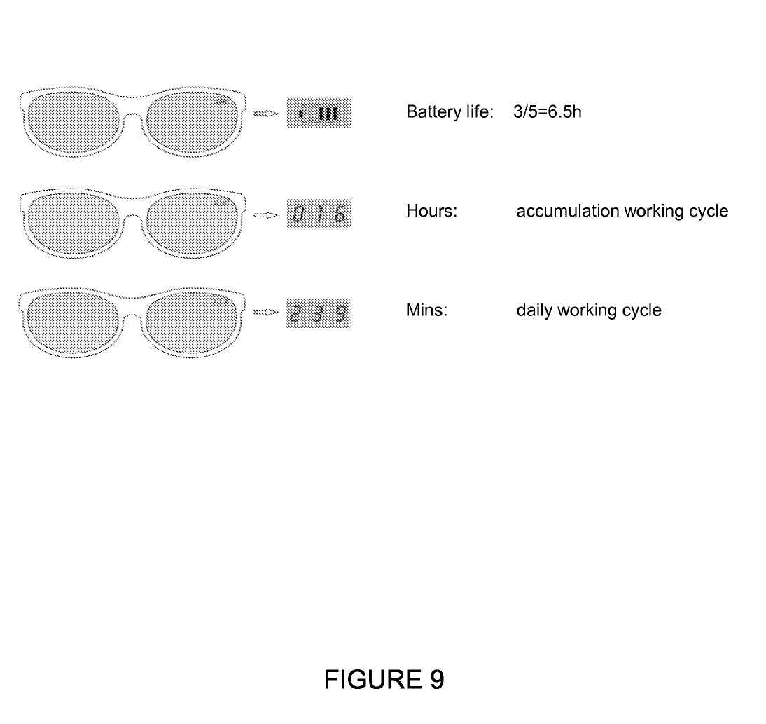

FIG. 9 shows an embodiment of a display which displays operational use information of the electronic eyewear according to an embodiment. The embodiment includes the display being located on a lens. However, it is to be understood that the display could be located at other areas of the eyewear, such as at an inside surface of a temple. For an embodiment, the display is on another device, such as, an external controller that can be interfaced wirelessly or wiredly with the electronic eyewear. Exemplary displayed information includes battery life (of a battery of the electronic eyewear), accumulation working cycle (which depicts the accumulated hours of wear of the electronic eyewear during period of time, such as, since a last session with a doctor), and a daily working cycle (which depicts, for example, the number minutes the electronic glasses have been worn during a current day).

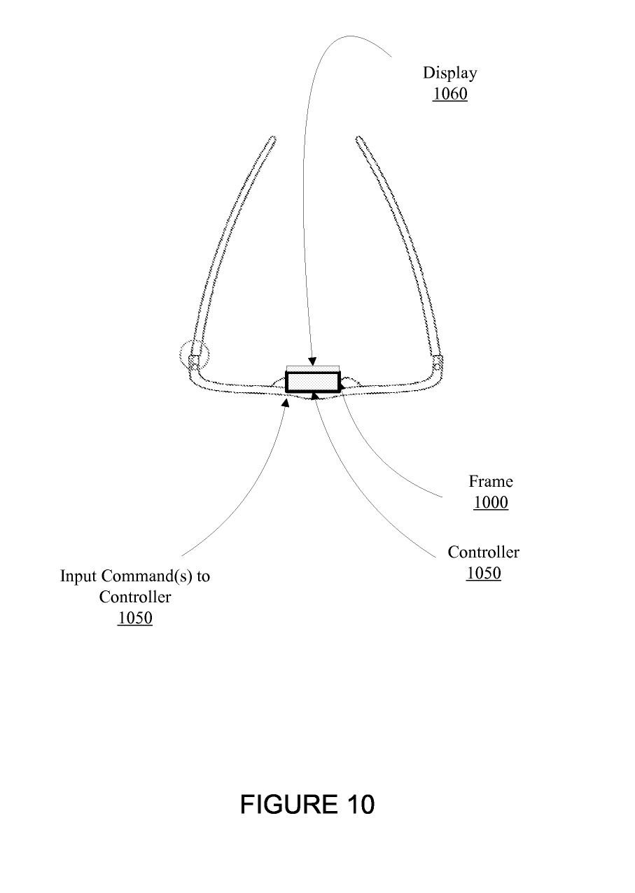

FIG. 10 shows another block diagram of electronic eyewear according to another embodiment. This embodiment includes a frame 1000, a controller 1050 and a display 1060. This embodiment more generally shows the electronic eyewear in which the controller 1050 receives one or more commands from one of many different possible sources. For an embodiment, the controller 1050 receives the one or more command from one or more physical switch located on the electronic eyewear. For another embodiment, the controller 1050 receives the one or more command from one of the previously described physical switch located at the hinges of the electronic eyewear. For an embodiment, the controller 1050 receives the commands from an external controller through an electronic interface of the electronic eyewear. For an embodiment, the controller 1050 receive one or more commands, and displays a use parameter of the eyewear on the display 1060 based on the one or more received commands.

For an embodiment, the use parameter includes timing of how long the eyewear has been worn by a user. For an embodiment, the use parameter includes when the eyewear has been worn by a user. For an embodiment, the use parameter includes a battery life of the eyewear.

The use parameter provides a user or a doctor with information related to the use of the glasses. The user parameter is not merely an indication of a setting provided to the electronic eyewear. For one embodiment, the use parameter provides a user or a doctor with information related to the use of the glasses.

For an embodiment, the display 1060 is located between the lenses on a side of the frame 1000 that is adjacent to a user's eyes when wearing the eyewear. For an embodiment, the one or more commands are received from an external controller. For an embodiment, the one or more commands are received from one or more switches located on the frame. For an embodiment, the electronic eyewear includes a pair of temple arms, and at least one switch, wherein the at least one switch is open or closed depending upon an angle of at least one of the temple arms relative to a frontal plane of the one or more lenses. For an embodiment, the one or more command are received from the at least switch based on whether the at least one switch is open or closed. For an embodiment, at least one switch includes a first switch and a second switch, wherein each switch is open or closed depending upon an angle of at least one of the temple arms relative to a frontal plane of the one or more lenses.

One of the described embodiments encourages the use of both eyes simultaneously so that the brain does not suppress input from one eye. Another embodiment forces an amblyopic eye to work harder.

In one embodiment, the lenses of an eyewear, such as a pair of glasses, could be LCD lenses.

One embodiment shutters the two lenses by alternately blanking the left and the right lens back and forth. For example, the shuttering speed of the lenses can be adjusted. This can be done, for example, by a knob, a slider or a small dial on the corresponding frame to program the frequency of the blanking. The switching speed can range from a few milliseconds to a short number of seconds. In another example, the switching frequency can range from 1 Hz to 15 Hz (such as in 1 Hz increment). In yet another example, the switching frequency can range from 6 to 10 Hz (such as in 0.5 Hz increment).

In another embodiment, the duty cycle of the blanking of the left and the right lens during the switching can be controlled. For example, their phase relationship can be 90 degrees, or at some other degrees. In another example, an amblyopic eye can be forced to work harder by having its corresponding lens turned on longer than the other lens. In yet another example, the shutter lenses can have different blocking times for each lens depending on which eye is more dominant or lazy.

An embodiment includes the application of a course therapy to a user (patient) wearing the electronic eyewear. For an embodiment, the course therapy includes an external computer, or the controller of the electronic eyewear automatically selected a blanking frequency, or a sequence of blanking frequencies. The selected blanking frequency or sequence of blanking frequencies can be automatically selected based on the condition of the user. The selected blanking frequency or sequence of blanking frequencies can be based on the identification of trends of responses observed from past users/patients. The selected blanking frequency or sequence of blanking frequencies can be identified as being successful or not based on testing/use with past users/patients.

Further, the blanking frequency or the sequence of blanking frequencies is applied to the shuttering eyewear of the user. For an embodiment, a physician observes the patient while the sequence of blanking frequencies is applied to the shuttering eyewear of the user. The physician can maintain the present setting, or based on monitoring or observation, or the physician can adjust the blanking frequency or sequence of blanking frequencies being applied to the patient. In some situations, a patient's mind can fatigue to an applied blanking frequency, and the blanking frequency is no longer effective. For an embodiment, the blanking frequency is changed to reduce or eliminate the effects of the fatigue.

An embodiment of the electronic eyewear is able to identify that a user/patent has developed a fatigue to a previously selected blanking frequency or the sequence of blanking frequencies. The electronic eyewear can then automatically modify the blanking frequency or the sequence of blanking frequencies to mitigate the effects of user/patient fatigue to the previously selected blanking frequency or the sequence of blanking frequencies.

In one embodiment, the different attributes of the shutter lenses can be programmable via switches (such as the previously described switches) on the corresponding frame or wirelessly via a remote control.

In one embodiment, the shutter lenses with the corresponding control circuitry and power source can be in a secondary frame, which is attachable to a primary frame via different mechanisms, such as magnets.

In one embodiment, the shutter lenses with the corresponding control circuitry and power source can be in a fit-over frame that can fit over another frame.

In one embodiment, the shutter lenses can be integrated into prescription lenses providing focal correction, such as bi-focal, tri-focal, prism, etc.

In one embodiment, the shutter lenses can auto-modulate to provide shading capability when used in sunny areas while still providing alternating vision blocking as described above.

In one embodiment, the shutter glasses are rechargeable or include power sources, such as a battery, to allow the glasses to perform its operation over a duration of time, such as a few hours.

In one embodiment, the shutter glasses may be secured from the back with a functional strap, such as a lanyard, that may contain the control circuitry and power source. This can provide additional ergonomic qualities and securing for active patients.

In one embodiment, the shutter glasses can be marketed to optometrists and ophthalmologists.

In yet another embodiment, the shutter frequency for the two lenses can be independently controlled.

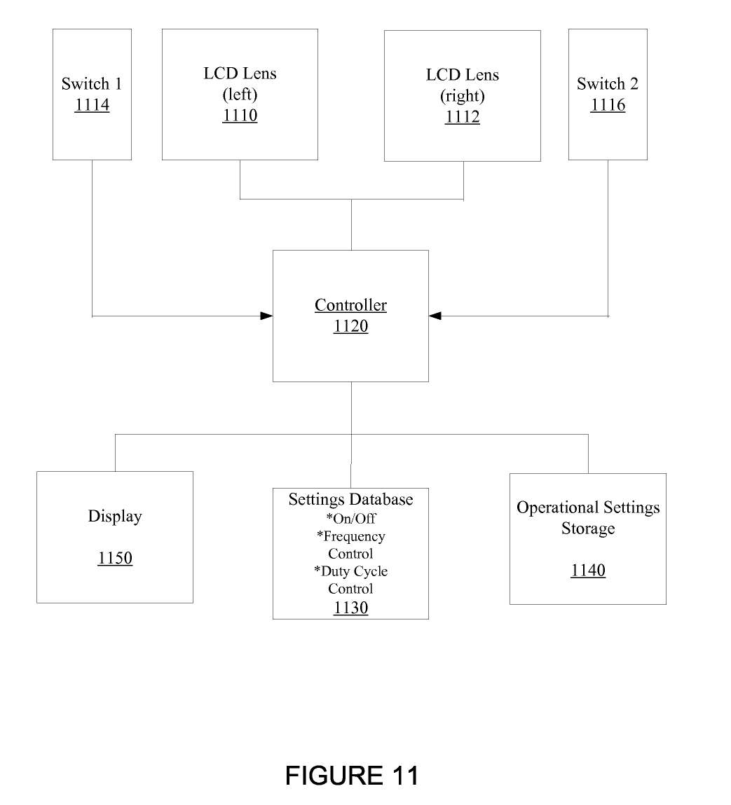

FIG. 11 shows a block diagram of electronic shutter glasses according to an embodiment. As shown, this embodiment of the shutter glasses includes a left lens 1110 and a right lens 1112. For an embodiment, the left lens 1110 and the right lens 1112 include LCD lenses.

For an embodiment, a controller 1120 provides control of at least one of frequency or blocking period (blocking time) of at least one of the first lens 1110 or the second lens 1112. For an embodiment, the left lens 1110 is operable to blank for a first blocking time, the right lens is operable to blank for a second blocking time, and the controller 1120 controllably sets at least one of the first blocking time and the second blocking time. For an embodiment, the control of at least one of frequency or blocking period is adjustable. For an embodiment, the control of the first lens 1110 is independent of the control of the second lens 1112. For an embodiment, the controller 1120 is at least partially controlled by switches 1114, 1116 that provide at least one of on/off control, frequency control, and/or duty cycle control. For an embodiment, a database 1130 includes selections for blanking frequency and duty cycle control. As previously described, the blanking frequency and duty cycle control can be updated as a patient develops fatigue to selected blanking frequencies and duty cycles. Further, the selected blanking frequency and duty cycle control can include sequences of blanking frequency and duty cycle control. For an embodiment, the frequency of the shuttering (switching from a non-block condition or state to a blocking condition or state) is the same for both lenses, but the blocking time or duty cycle of one lens is different than the blocking time or duty cycle of the other lens, thereby forcing one eye of a user to work harder than the other eye.

For an embodiment, the controller 1120 is operable to access operational settings of at least the frequency and/or duty cycle from operational setting storage 1140. For an embodiment, the operational settings can be adaptively updated depending upon an eye ailment a user of the shutter glasses is suffering from. Additionally, for an embodiment, the storage 1140 is used for storing monitoring information that can be accessed.

For an embodiment, at least one of the first switch 1114 or the second switch 1116 is operational to provide commands to the controller 1120.

For an embodiment, a display 1150 provides use information of the electronic glasses. For an embodiment, the information of the display is provided by the controller 1120 as commanded by the first switch 1114 or the second switch 1116.

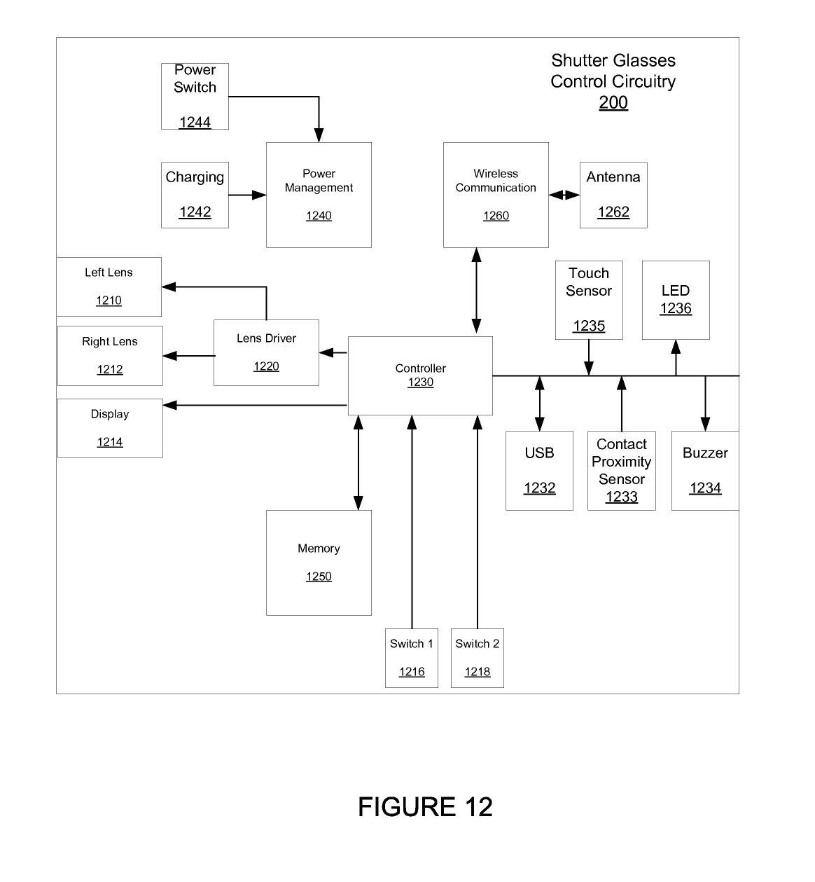

FIG. 12 shows a block diagram of electronic shutter glasses according to another embodiment. This embodiment provides examples of different types of functionality that can be included with the shuttering glasses control circuitry 1200.

An embodiment includes a controller 1230 that controls at least one of frequency or blocking times of at least one of a left lens 1210 and a right lens 1212. The controller 1230 can interface with an external controller.

For an embodiment, the controller 1230 interfaces with a lens driver 1220 that drives states of the left lens 1210 and the right lens 1212. For an embodiment, the lenses 1210, 1212 include LCD lenses. Accordingly, for this embodiment, the lens driver is an LDC lens driver.

For an embodiment, the states of the left lens 1210 and the right lens 1212 include a blocking state (the lens being opaque and not letting light pass through) and a non-blocking state (the lens being transparent and letting a majority of light pass through). An embodiment includes intermediate states that allow varying amount of light pass through the lenses depending upon the intermediate state. The process of blanking includes the lenses alternating between blocking and non-blocking.

For an embodiment, the controller 1230 interfaces with memory 1250. For an embodiment, the controller 1230 accesses from the memory 1250 stored operational modes of the states of the left lens 1210 and the right lens 1212. For an embodiment, the controller 1230 stores operational information of the shuttering glasses in the memory 1250 for future access. For an embodiment, the operational information includes user usage of the shuttering glasses. For an embodiment, the operational information includes monitored or collected information of the user. The monitored information can be access by an external controller, thereby allowing determination of compliance by the user of the shutter glasses. That is, compliance by the user properly wearing the shutter glasses for a prescribed duration of time can be determined by accessed storage of wearing times and patterns by the user of the shutter glasses.

An embodiment includes power management 1240 of the shuttering glasses. For an embodiment, the shuttering glasses include a battery. For an embodiment, a charging unit 1242 controls charging of the battery. An embodiment includes a power switch 1244. For an embodiment, the power management 1240 provides and distributes electrical power to, for example, at least one of the lens driver 1220, the controller 1230, the memory 1250, wireless communication circuitry, a touch sensor 1235, an LED (light emitting diode) 1236, a USB (universal serial bit) interface 1232, a contact sensor 1233 and/or a buzzer 1234.

An embodiment includes wireless communication circuitry 1260 that allows the controller 1230 to communicate with an external controller. For an embodiment, wireless communication circuitry 1260 is two-way in that the controller 1230 can either provide the external controller with information, or the controller 1230 can receive information from the external controller. An embodiment further includes an antenna 1262 for enabling the wireless communication. The wireless communication can be continuous or intermittent.

An embodiment includes the touch sensor 1235. For an embodiment the touch sensor 1235 allows a user to communicate with the controller 1230. For an embodiment, the touch sensor 1235 allows the controller 1230 to monitor the user of the shutter glasses.

An embodiment includes the LED 1236. For an embodiment, the LED 1236 allows the shutter glasses to provide visual communication to, for example, the user. For an embodiment, the LED 1236 provides a visual indicator that the shutter glasses have electrical power indicating, for example, that the shutter glasses are electrically turned on.

An embodiment includes the USB port 1232 for providing wired communication to or from the controller 1230. For example, an external controller can communicate with the controller 1230 through the USB port 1232.

An embodiment includes the contact/proximity sensor 1233. For an embodiment, the contact/proximity sensor 1233 provides an indication that the shutter glasses are being worn. For an embodiment, the controller 1230 monitors the usage (wearing of the shutter glasses) based on the contact/proximity sensor 1233.

An embodiment includes the buzzer 1234. For an embodiment, the buzzer 234 provides audible communication to, for example, the user. For an embodiment, the buzzer indicates to the user that the battery is low. For at least some embodiments, the buzzer is used to provide guidance to the user. For example, the buzzer can provide an indicator to the user to either take off or put the shutter glasses on.

For an embodiment, at least one of a first switch 1216 or a second switch 1218 is operational to provide commands to the controller 1230.

For an embodiment, a display 1214 provides use information of the electronic glasses. For an embodiment, the information of the display is provided by the controller 1230 as commanded by the first switch 1216 or the second switch 1218.

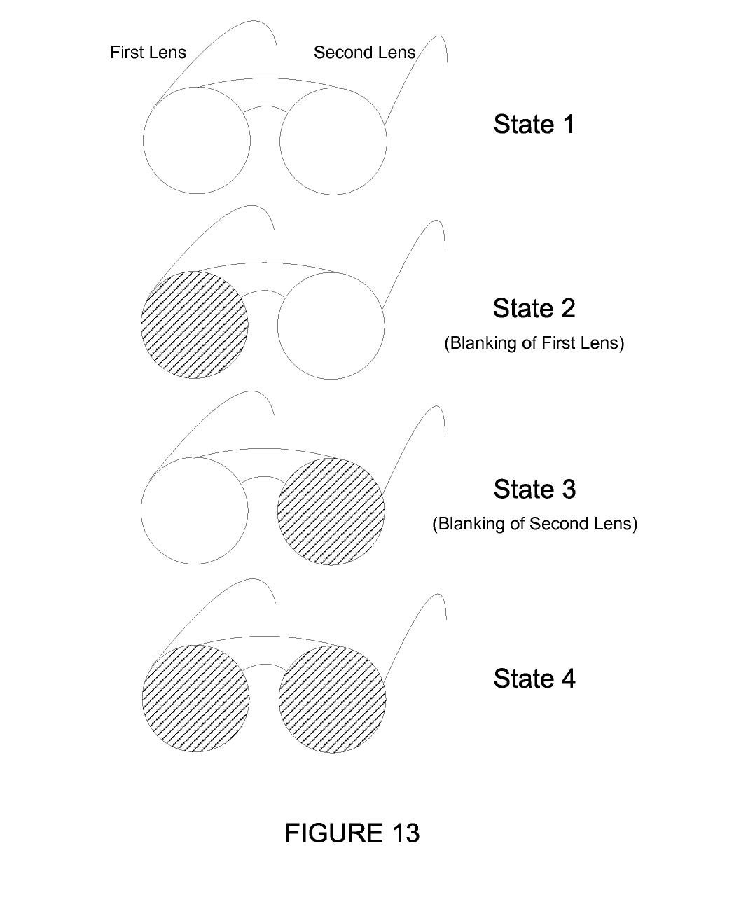

FIG. 13 shows shutter glasses in different states of operation according to an embodiment. As shown, an embodiment includes a first state wherein both a first lens and a second lens are in non-blocking. For an embodiment, a second state includes one lens (for example, the first lens) being in the blocking state, and the other lens (for example, the second lens) being in the non-blocking state. For an embodiment, a third state includes the other lens (such as, the second lens) being in the blocking state, and the lens (such as, the first lens) being in the non-blocking state. For an embodiment, a fourth state includes both lenses being in the blocking state. As described, at least some embodiments include controlling at least one of a frequency of the change from one state to at least one of the other states, or a blocking period (and conversely, the non-blocking period) of one or more of the states.

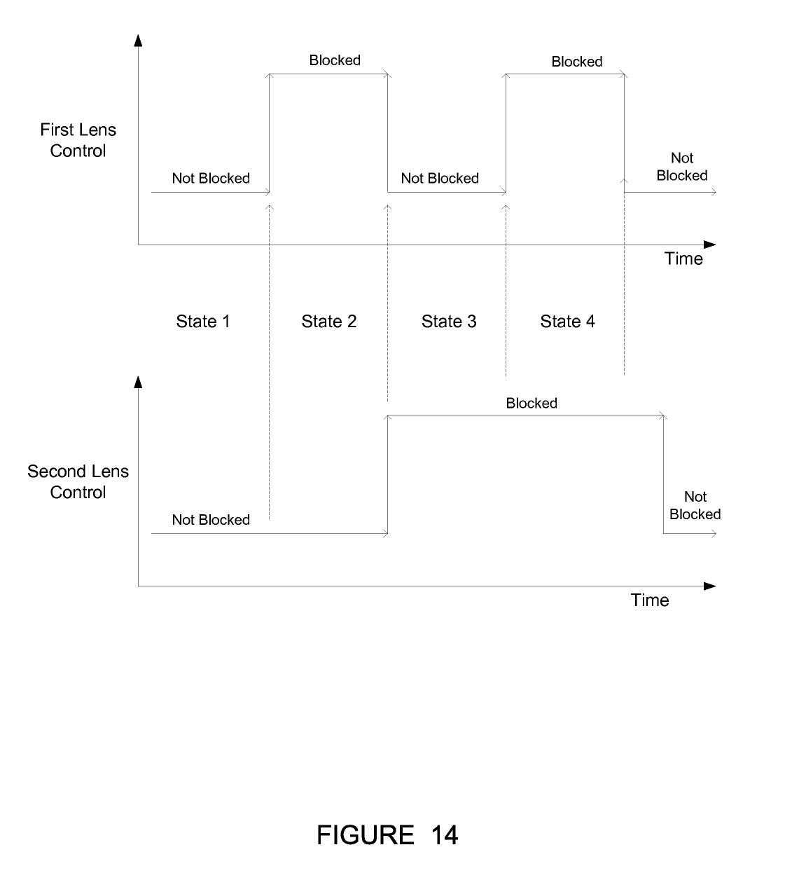

FIG. 14 shows time-lines of operation of the shutter glasses for the states shown in FIG. 13, according to an embodiment. A first time line shows control of the first lens over time between being non-blocked and blocked. A second time line shows control of the second lens over time between being non-blocked and blocked. The four possible states of FIG. 13 are shown by the time-lines of FIG. 14 according to an embodiment.

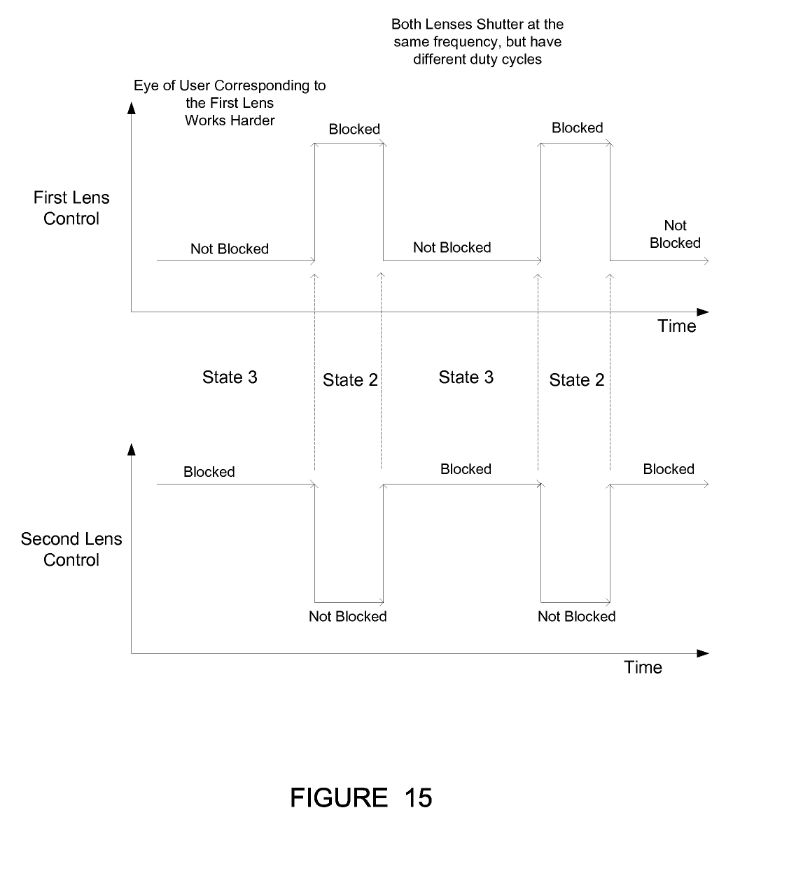

FIG. 15 shows time-lines of operation of the shutter glasses for the states shown in FIG. 13, according to another embodiment. This embodiment includes the blocking period of the first lens being less than the blocking period of the second lens while alternately blanking (blocking) the left and the right lens back and forth. For this embodiment, the frequency of the shuttering of both lenses is approximately the same. The second lens is blocking for a greater percentage of a period of the frequency of the shuttering than the first lens. Accordingly, a user of the shutter glasses is forced to use vision of the eye that corresponds with the first lens a greater percentage of time. By blocking an eye (through blanking the corresponding lens) the shutter glasses force the brain of the user to switch over to the other eye. That eye (corresponding to the lens not being blanked) is forced to align properly to see the same target of interest, and the brain continues to use that eye until the cycle repeats and switches to the other eye. The shuttering causes the user of the shutter glasses to experience a combination of muscle alignment training and anti-suppression therapy.

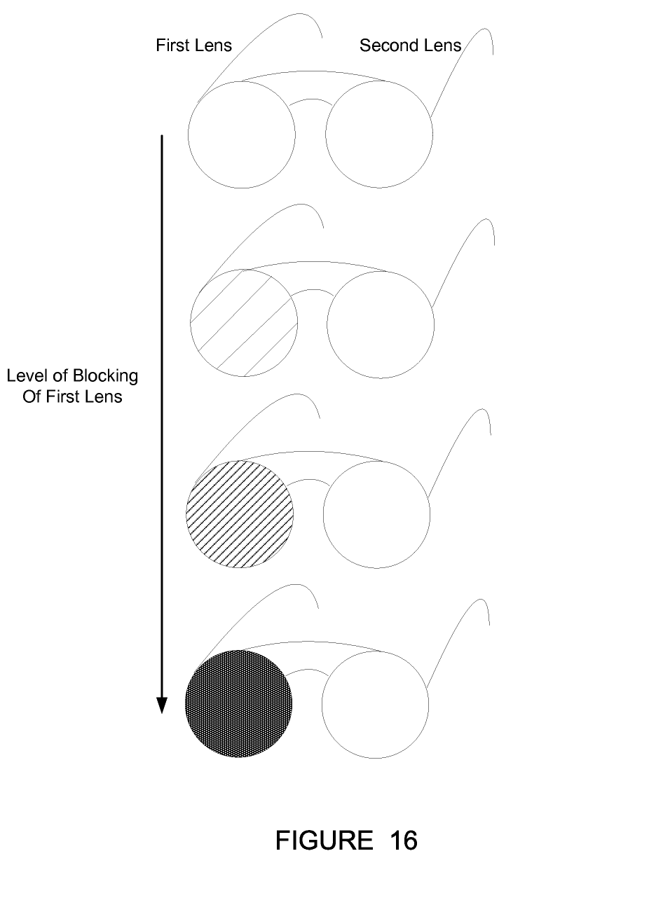

FIG. 16 shows shutter glasses that include an adjustable level of blocking, according to an embodiment. For an embodiment, the level or degree of blocking of either of the lenses is adjustable. That is, the amount of light that passes through at least one of the shuttering glasses lenses is adjustable. FIG. 16 shows the first lens of the shuttering glasses, wherein the level or degree of the blocking is adjusted from near-transparent to near-opaque, with intermediate levels or degrees of blocking in between. For at least some embodiments, the level of blocking can be increased slowly or rapidly, and then the blocking can be independently decreased slowly or rapidly. Therapy being applied to the user of the shutter glasses can dictate how to control the blocking and the levels of blocking of either lens.

At least one embodiment includes adjusting the level according to any desired sequence. For example, the level of block can be increased or decreased as desired or programmed. The level of blocking of either lens can be dependently or independently controlled.

For an embodiment, the partial blocking of a lens include block portions of the lens, wherein the portion is selectable.

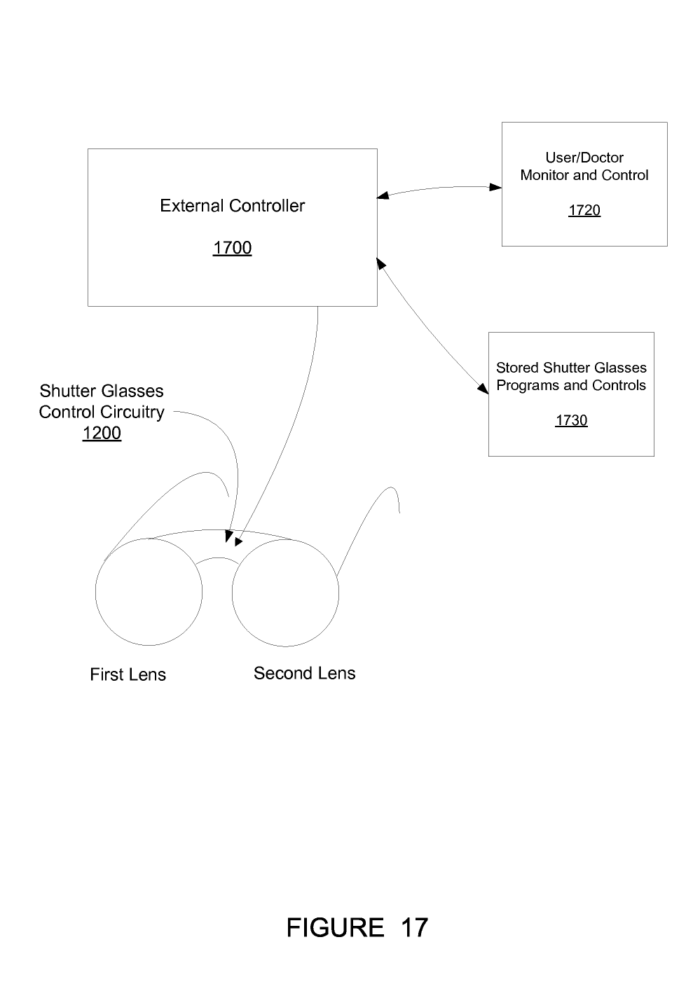

FIG. 17 shows shutter glasses interfaced with an external controller, according to an embodiment. For an embodiment, shuttering glasses control circuitry 200 is operable to communicate, for example, with an external controller 1700. For an embodiment, the external controller allows a user or a doctor to monitor (1720) the usage of the user. For an embodiment, the user or the doctor is able to program the shuttering glasses through the external controller 1700. For an embodiment, the user or doctor can retrieve stored shuttering glasses program and controls 1730. Accordingly, the doctor can proscribe therapy by programming the shutter glasses. Additionally, the doctor can monitor the use of the shutter glasses by the user (patient), thereby allowing the doctor to monitor compliance and use of the shutter glasses by the user. Further, sensors can be included that monitor activity by the user which can be stored.

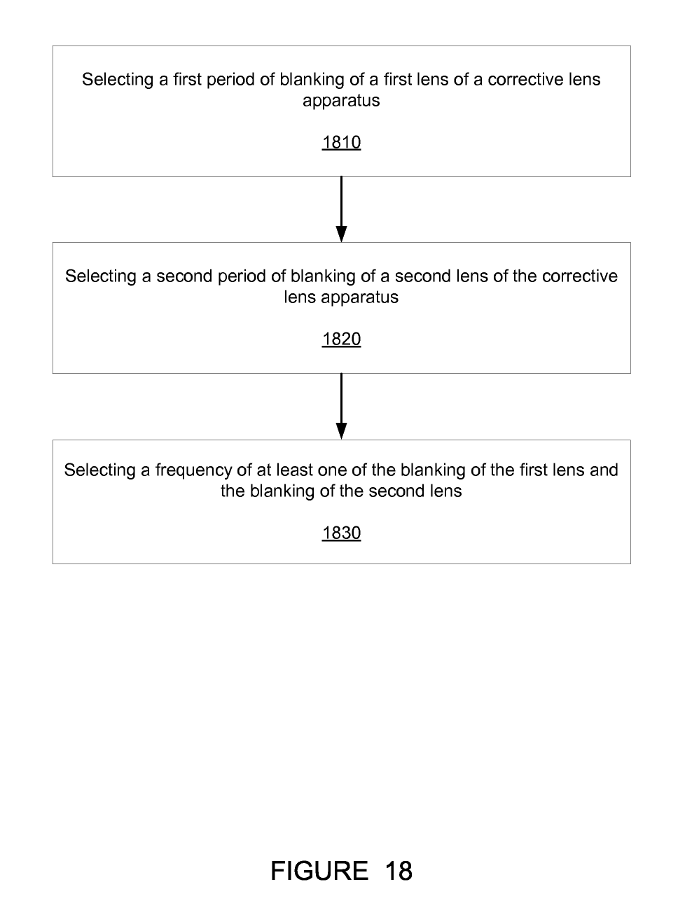

FIG. 18 is a flow chart that includes steps of a method of treating vision of a patient, according to an embodiment. A first step 1810 includes selecting a first period of blanking of a first lens of a corrective lens apparatus. A second step 1820 includes selecting a second period of blanking of a second lens of the corrective lens apparatus. For an embodiment, the first period and the second period are selected for treating a vision ailment of the patient. For example, the first period can be selected to be different than the second period to force one eye of the patient to work harder than the other eye of the patient. A third step 1830 includes selecting a frequency of at least one of the blanking of the first lens and the blanking of the second lens. For example, particular frequencies of blanking may be determined to be more effective in treating the patient than others. For an embodiment, the frequency is selective and adjustable depending upon how the shutter glasses are programmed or set.

One embodiment of the invention encourages the use of both eyes simultaneously so that the brain does not suppress input from one eye. Another embodiment helps an amblyopic eye to work harder. Other embodiments address other issues regarding the eyes.

As previously described, in a number of embodiments, the lenses of a pair of eyewear can be shuttered, and the shutter frequency can be adjusted. For example, the two lenses can be shuttered by alternately blanking the left and the right lens back and forth, with one lens shut and the other open, and vice versa. To illustrate, the shutter frequency can range from a few milliseconds to a few seconds. In one example, the shutter frequency can range from 1 Hz to 15 Hz. In another example, the shutter frequency can range from 6 to 10 Hz. In yet another example, the shutter frequency does not exceed the frequency where the shutter can be visually perceived by an average person. As to the increment within a range, the increment can be, for example, in 0.5 Hz, 1 Hz, 2 Hz, 3 Hz, or other increments.

In at least some embodiments, various ranges of shutter frequency for one or both of the two lenses are selectable. One embodiment includes a doctor or physician (or other) selecting the range or ranges of shutter frequency based at least in part on a vision or eye ailment of a patient or user. For example, a therapy of a first ailment may be optimally provided with a first range of shutter frequencies, and a therapy of a second ailment may be optimally provided with a second range of shutter frequencies. Other factors can influence the selected range of shutter frequency as well. For example, experimentation may determine that the desired shutter frequency changes with, for example, age, time, environment, race etc. One embodiment includes a doctor or physician (or other) selecting the shutter frequency based upon the results of one or more tests performed on the patient. For example, various ranges of shutter frequency may be tested by having the patient wear a pair of shutter glasses, and while wearing the shutter glasses operating at various shutter frequencies, having the patient perform one or more tests. As illustrations, one selected range can be from one to ten hertz. Another can extend the low end of the range to a period of one or more days.

One embodiment includes sensing when the patient is actually wearing a pair of shutter glasses. This can be done, for example, by incorporating a being-worn sensor in the glasses. The sensor can determine, for example, if the temples of the glasses are in the extended position. One embodiment further includes monitoring if the user is wearing the glasses. In one embodiment, a pair of shutter glasses includes a time sensor that times at least one of how long and how frequently the patient wears the glasses. For an embodiment, the time sensor is attached to, integral with, or being a part of the shutter glasses. For an embodiment, information related to the monitoring/sensing of the glasses is stored, such as in the glasses. For an embodiment, after stored, the monitoring information can be later retrieved, for example, by a doctor or physician to allow the physician to determine or gauge the compliance (e.g. duration of time of wearing the glasses) by the patient with the therapy suggested by the doctor of physician. The retrieval can be performed wired (e.g. via an electrical connector at the glasses) or wirelessly (e.g. via an infrared sensor at the glasses).

For one embodiment, a time sensor senses when the patient puts the shutter glasses on his/her head. As described, for an embodiment, this includes a “being worn” sensor. Another embodiment includes the time sensor being activated by a triggered event, such as, pressing a button or a switch located on the glasses.

In one embodiment, a motion detector is used as the “being worn” sensor. A threshold can be set, such that if the amount of motion exceeds the threshold, the eyewear is assumed to be worn. The motion detector can, for example, be achieved by a mechanical means or an accelerometer.

In another embodiment, the “being worn” sensor includes two thermal sensors. One sensor can be at approximately the middle of a temple, such as in a region that touches the head of the user wearing the glasses. The other sensor can be at the end of the temple, close to its hinge. If the temperature differential between the two sensors is beyond a certain preset value, the eyewear would be assumed to be worn. The differential is presumed to be caused by a person wearing the pair of glasses.

In yet another embodiment, the “being worn” sensor includes a stress sensor at the hinge of the temple. The assumption is that when the eyewear is worn, the hinge is typically slightly stretched because typically, the width of the head of the user is slightly wider than the width between the temples when the two temples are in the extended positions. If the value of the stress sensor is beyond a certain preset value, the glasses would be assumed to be worn.

In a further embodiment, the “being worn” sensor can be a switch. For example, at the hinge between a temple and its corresponding lens holder, there is a switch. When that temple is fully extended outwards, the switch is turned on. The switch can be a pin. When the temple is fully extended outwards, the pin is pressed. When both temples are fully extended outwards, in one embodiment, the glasses would be assumed to be worn by the user.

In addition to monitoring pertaining to the wearing of a pair of glasses by a patient, the monitoring can include monitoring the therapies applied to the patient. In yet another embodiment, the monitoring further includes monitoring characteristics of a patient. For example, eye movement or head movements of the patient while therapy is being applied through different types of sensors in the shutter glasses. Again, the monitoring information can be stored for later retrieval. For example, a doctor or physician can retrieve the monitoring information for not only a determination of compliance by the patient, but also to obtain additional patient information obtained while the patient is wearing the glasses and being treated with therapy provided by the shutter glasses.

In one embodiment with two lenses, the shuttering of each lens is controlled by a waveform, such as a voltage waveform, and the phase relationship between the waveforms of the two lenses can be adjusted. In one example, the phase can be approximately 90 degrees. In another example, the phase relationship can be at some other degrees.

In one embodiment, the shutter frequency of the two lenses can be independently controlled.

In one embodiment, the shutter lenses described herein can also modify its transmission or tint amount. As an example, the shutter lenses can auto-modulate to provide shading capability when used in sunny areas. As another example, the amount of transmission can be reduced manually, such as via a switch at the corresponding frame, if used before a bright monitor. It has been found that in some situations, the monitor brightness is directly related to computer-inflicted eye strain. In another embodiment, the two lenses of a frame can be independently adjustable for their transmission amount.

There can be different applications to changing the transmission coefficient. One example is for amblyopic eyes. The transmission coefficient of the lens for the good eye can be reduced to a very low level, such as 10% or less, or around 5%, instead of substantially blocking all the light to the good eye. Some users may feel more comfortable if their eyes could see something, instead of having all their vision blocked.

Another application regarding tinting or mirroring the lenses of a pair of shutter glasses is to make the shuttering less conspicuous. The low-frequency shuttering of the glasses may be visible to others who are proximate to the patient, thereby potentially drawing unwanted attention to the patient. This unwanted attention may cause the patient to not wear the glasses or wear the glasses less. By tinting or mirroring the lenses of the glasses, the effects of the shuttering may be at least partially disguised, thereby reducing the potential of unwanted attention by others. The tinting or mirroring of the lenses can be realized by, for example, coating the lenses with a mirror coat. In one embodiment, such coating can be known as a flash coating or a REVO coating.

In one embodiment, the transmission coefficient of a lens is not uniform across the lens. For example, the lens can be separated into zones. Using liquid crystal as an example, a lens driver circuit can provide electrical signals to one or more zones as in addressing liquid crystal display panels. To illustrate, the zones can be columns or vertical zones. As another illustration, the zones can be rows across a lens. In yet another illustration, a zone can be a region where a row intersects a column. With columns as an example, each column can be individually addressable by its corresponding conductors to control its transmission coefficient. One application of such an implementation is to train the brain to move an eye to areas of a lens where the eye could see. Assume that each of the two lenses of a pair of glasses is separated into ten evenly-spaced columns. After detailed analysis, an optometrist decides to block light, or at least a portion of the light, coming into the left side of the left eye so as to encourage the left eye to move more towards the nose. Then the optometrist operates the lens driver circuit so that the left three columns of the left lens block off light, with the remaining seven columns allowing light to go through. In another implementation, the lens driver circuit could implement a discrete gradient change in any direction using programmable transmission for each column.

In one embodiment, the transition for shuttering is not abrupt, but is gradual. In other words, the rate of change of the transmission coefficient can be gradually, such as in a linear or sinusoidal fashion, or via other types of waveforms. In some situations, a more gradual change in the transmission coefficient, such as during shuttering, can be more soothing to the eyes.

In one embodiment where the shuttering transition is more abrupt, such as in the waveform of a substantially rectangular wave, the on/off duty cycle of the shuttering of the lenses can be controlled. In one example, the duty cycle is 50%. In another example, the duty cycle is at some other percentages. In another embodiment with two lenses, the duty cycle of each of the lenses can be independently controlled.

In one example, an amblyopic eye can be forced to work harder by having its corresponding lens turned on longer than the other lens. In another example, there can be different blocking times for each lens, depending on which eye is more dominant or lazy. In yet another example, the lens for the normal eye can be shuttered, while the lens for the amblyopic eye is left unblocked, or does not shutter.

In one embodiment with two lenses, the change in transmission characteristics of each lens is controlled by a waveform, and the waveforms for the two lenses can be different. The two waveforms can differ in frequency, transmission amount, the abruptness of the shuttering if applicable, and/or the on/off duty cycle if applicable.

In one embodiment, the one or more attributes of the shutter lenses can be programmable via one or more switches on the corresponding frame. Examples of switches on a frame can include a knob, a slider or a small dial on the corresponding frame to program, such as the frequency of the shuttering or blanking. In another example, the one or more attributes of the shutter lenses can be programmed wirelessly, such as by a remote control.

In one embodiment, the shutter lenses can be integrated into prescription lenses, providing focal correction, such as bi-focal, tri-focal, prism, etc.

In one embodiment, the shutter lenses are based on liquid crystal lens technologies.

In one embodiment, an eyewear includes a single lens. As an example, the lens could be a single wrap-around lens.

In one embodiment, a distance between each lens of, for example, a pair of shutter glasses is no less than 13 mm, or the shortest distance between lenses is no less than 13 mm.

In one embodiment, the electronics for the shutter lenses are in an eyewear frame with the shutter lenses. In another embodiment, the shutter lenses with the corresponding electronics, such as the control circuitry, can be in a secondary frame, which is attachable to a primary frame via different mechanisms, such as magnets. The primary frame can include a pair of prescription lenses. To illustrate, there can be a housing or a chassis holding prescription lenses, with the shutter lenses provided on the outside, such as via a clip-on. In another example, the shutter lenses with the corresponding control circuitry can be in a fit-over frame that can fit over another frame.

In one embodiment, the electronic eyewear with shutter glasses is rechargeable or includes power sources, such as a battery, to allow the glasses to perform its operation over a duration of time, such as a few hours.

At least some embodiments include electronic-glasses therapy-providing systems and methods. For an embodiment, pre-selectable therapies are pre-stored, and accessible by a therapy provider (for example, a doctor or physician). For an embodiment, the pre-selectable therapies are based upon prior testing and experience with patients that suffer similar maladies. Based upon conditions being suffered by a present patient, one or more pre-selectable therapies can be downloaded to an electronic eyewear according to an embodiment. For an embodiment, a server, or a computer, accessible by a therapy provider, is operable to provide a user interface to the therapy provider that allows the therapy provider to easily select one of the pre-selectable therapies based on at least one condition of the patient (user). For an embodiment, the user interface includes a menu that provides therapy selections. The electronic therapy providing system provides an easy way for the therapy provider to select a therapy, and then down load to the electronic eyewear the selected therapy.

For an embodiment, a selected therapy is down loaded to an electronic eyewear of the patient from the therapy provider's computer, or from a remote server. As described, for an embodiment, the electronic eyewear includes a wired or wireless interface that allows the electronic eyewear to interface with an external controller, such as, the therapy provider's computer or the remote server.

At least some embodiments include monitoring the use of the electronic eyewear of the user (patient). The monitoring allows the patient and the therapy provider to have information regarding how well the patient has complied with the selected therapy. Further, with the monitoring of use, reminders can be provided to the user if the user is not properly complying with the suggested use of the electronic eyewear per the proscribed therapy. Further, the monitored use can be remotely communicated back to the therapy provider.

The monitored user further allows the therapy provider to determine how well the applied therapy is working. If the selected therapy is not working as desired, additional therapy selections can be made. The additional therapy selections can be aided by the monitored use of the electronic eyewear during the previously provided therapy. Again, for an embodiment, the additional selections can easily and/or automatically be made for or by the therapy provider. For an embodiment, the electronic-glasses therapy-providing systems and methods provide the additional selections, which, for an embodiment, can be made by the therapy provider through, for example, menus of a user interface.

For an embodiment, a therapy depends on the blanking frequency or a sequence of blanking frequencies. A downloaded therapy will automatically apply the corresponding blanking frequency to the shuttering eyewear of a user. For an embodiment, a physician observes the patient while the sequence of blanking frequencies is applied to the shuttering eyewear of the user. The physician can maintain the present setting; or based on monitoring or observation, the physician can adjust the blanking frequency or sequence of blanking frequencies being applied to the patient. This adjustment, for example, can be done via menu selection of different therapies by the physicians. In some situations, a patient's mind can fatigue to an applied blanking frequency, and the blanking frequency may no longer be effective. For an embodiment, the blanking frequency is changed to reduce or eliminate the effects of the fatigue. For at least some embodiments, the blanking frequency or sequence of blanking frequencies are predetermined and automatically selected and downloaded to the electronic eyewear of a user based on the conditions of the user.

Although specific embodiments have been described and illustrated, the embodiments are not to be limited to the specific forms or arrangements of parts so described and illustrated. The embodiments are limited only by the appended claims.

What is claimed:

1. An apparatus, comprising:
a frame that includes a pair of temple arms forming eyewear that is adaptable to hold one or more lenses;
at least one switch, wherein the at least one switch is open or closed depending upon an angle of at least one of the temple arms relative to a frontal plane of the one or more lenses.

2. The apparatus of claim 1, wherein the at least one switch is located within at least one hinge formed between the frame and at least one of the pair of adjustable temple arms.

3. The apparatus of claim 2, wherein the at least one switch includes a spring mechanism that urges the at least one switch to be at least one of open or closed.

4. The apparatus of claim 1, wherein the at least one switch is located within at least one hinge formed between the one or more lenses and the pair of adjustable temple arms.

5. The apparatus of claim 4, wherein the at least one switch is open or closed depending on whether the angle is less than or greater than X degrees.

6. The apparatus of claim 5, wherein the at least one switch is closed if the angle is greater than X degrees, and open if the angle is less than X degrees.

7. The apparatus of claim 1, wherein the at least one switch includes a first switch located within a first hinge formed between the frame and a first adjustable temple arm of the pair of adjustable temple arms, and a second switch located within a second hinge formed between the frame and a second adjustable temple arm of the pair of adjustable temple arms.

8. The apparatus of claim 7, wherein the first switch is open or closed depending on whether a first angle of the first hinge is less than or greater than X degrees, and the second switch is open or closed depending on whether a second angle of the second hinge is less than or greater than Y degrees.

9. The apparatus of claim 1, further comprising a controller.

10. The apparatus of claim 9, wherein the controller is operative to monitor a state of the apparatus by depending on whether the at least one switch is open or close.

11. The apparatus of claim 10, wherein the monitored state comprises monitoring whether a user is wearing the glasses.

12. The apparatus of claim 7, further comprising a controller.

13. The apparatus of claim 12, wherein the controller is operative to monitor a state of the apparatus by monitoring whether the first switch is open or close and whether the second switch is open or closed.

14. The apparatus of claim 12, wherein the monitored state comprises monitoring whether a user is wearing the glasses.

15. The apparatus of claim 12, wherein the controller is operative perform a command, wherein the command is determined based on whether the first switch is open or closed and whether the second switch is open or closed.

16. The apparatus of claim 15, wherein the command includes at least one of a system on/off command, a display functioning cycle-time, battery life display, an LCD frequency adjust, a reset.

17. The apparatus of claim 15, wherein a first command is performed if both the first switch and the second switch are closed, a second command is performed if the first switch is closed and the second switch is open, a third command is performed if the first switch is open and the second switch is closed, and a fourth command is performed if both the first switch and the second switch are open.

18. The apparatus of claim 15, wherein the command includes providing an indicator of how long the user has worn the glasses.

19. The apparatus of claim 15, wherein the command includes providing an indicator of how long the user has worn the glasses for a given day.

20. The apparatus of claim 15, further comprising a battery, and wherein the command includes providing an indicator of a remaining lifetime of the battery.

21. The apparatus of claim 1, wherein a display is located between the lenses on a sided of the frame that is adjacent to the user's eyes when wearing the eyewear.

22. The apparatus of claim 1, further comprising a controller and a wireless transceiver.

23. The apparatus of claim 22, wherein the controller is operative to communicate with a second controller through the wireless transceiver.

24. An apparatus, comprising:
a frame forming eyewear that is adaptable to hold one or more lenses;
a display;
a controller, wherein the controller is operative to:
receive one or more commands; and
display a use parameter of the eyewear on the display based on the one or more received commands.

25. The apparatus of claim 24, wherein the use parameter includes timing of how long the eyewear has been worn by a user.

26. The apparatus of claim 24, wherein the use parameter includes when the eyewear has been worn by a user.

27. The apparatus of claim 24, wherein the use parameter includes a battery life of the eyewear.

28. The apparatus of claim 24, wherein the display is located between the lenses on a side of the frame that is adjacent to a user's eyes when wearing the eyewear.

29. The apparatus of claim 24, wherein one or more commands are received from an external controller.

30. The apparatus of claim 24, wherein one or more commands are received from one or more switches located on the frame.

31. The apparatus of claim 24, wherein the apparatus further comprises:
a pair of temple arms; and
at least one switch, wherein the at least one switch is open or closed depending upon an angle of at least one of the temple arms relative to a frontal plane of the one or more lenses.

32. The apparatus of claim 31, wherein the one or more command are received from the at least switch based on whether the at least one switch is open or closed.

33. The apparatus of claim 32, wherein the at least one switch includes a first switch and a second switch, wherein each switch is open or closed depending upon an angle of at least one of the temple arms relative to a frontal plane of the one or more lenses.

34. The apparatus of claim 24, wherein the one or more lenses includes a first lens and a second lens, and wherein the first lens is operable to blank for a first blocking time, the second lens is operable to blank for a second blocking time; and further comprising:
a controller for controllably setting at least one of the first blocking time and the second blocking time.

35. The apparatus of claim 34, wherein the first lens and the second lens alternate between blocking and non-blocking.

36. The apparatus of claim 34, wherein during the first blocking time, the first lens substantially prevents light from passing through the first lens, and during the second blocking time, the second lens substantially prevents light from passing through the second lens.

37. The apparatus of claim 34, wherein when not operating within the first blocking time, the first lens substantially allows light to pass through the first lens, and when not operating within the second blocking time, the second lens substantially allows light to pass through the second lens.
